(19) United States
(12) Patent Application Publication
(10) Pub. No.: US 2024/0419709 A1
(43) Pub. Date: Dec. 19, 2024

(54) DEVICES, SYSTEMS, AND METHODS FOR IMPLEMENTING AN LLM TAG IN A LARGE LANGUAGE MODEL

(71) Applicant: Microsoft Technology Licensing, LLC, Redmond, WA (US)

(72) Inventors: Ross Faulkner SMITH, JR., Eastsound, WA (US); Jason Allen WEUM, Moorhead, MN (US); Samuel Elliot LARSON, Fargo, ND (US); Donald Lee BALL, JR., McLendon-Chisholm, TX (US); Maria Teresa CUBINO GONZALEZ, Estoril (PT)

(21) Appl. No.: 18/211,182

(22) Filed: Jun. 16, 2023

(51) Int. Cl. G06F 16/335; G06F 16/38

(52) U.S. Cl. CPC G06F 16/335; G06F 16/381

(57) ABSTRACT

A LLM receives a query and prepares a response from input data. The LLM identifies an LLM tag in the input data. The LLM processes the input data based on instructions in the LLM tag. The LLM tag includes instructions that may instruct the LLM to keep a subset of data together, request external input, and/or identify a version of a document. The LLM prepares a response to the query based on the LLM tag.

### CROSS-REFERENCE TO RELATED APPLICATIONS

N/A.

### BACKGROUND

Large language models (LLMs) such as ChatGPT utilize large sets of input data in the form of text. An LLM analyzes the input data and identifies patterns. The LLM receives an input query. Based on the analysis of the input data and the associated patterns, the LLM may prepare a response to the query. The response to the query may have varying relevance based on the input data used, the LLM's interpretation of the query, the patterns identified by the LLM, any other factor, and combinations thereof. Indeed, significant effort has been made to prepare the models. But current systems do have limited tools and processes to validate the accuracy of results from an LLM or other foundation model.

### BRIEF SUMMARY

In some aspects, the techniques described herein relate to a method implemented by a large language model (LLM). The LLM receives input data for the LLM. The LLM identifies an LLM tag in the input data. Based on a query, the LLM processes the input data with the LLM based on the LLM tag. The LLM generates a response to the query from the LLM.

In some aspects, the techniques described herein relate to a method for preparing information for a large language model (LLM). The method includes receiving input data for the LLM. The input data is reviewed for an action point. An LLM tag is added to the input data for the action point. The LLM tag includes an instruction for the LLM when the LLM processes the input data.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a LLM system, according to at least one embodiment of the present disclosure;

FIG. 2 is a representation of a LLM system illustrating the flow of information through an LLM, according to at least one embodiment of the present disclosure;

FIG. 3 is a flowchart of a method implemented on an LLM, according to at least one embodiment of the present disclosure;

FIG. 4 is a flowchart of a method implemented on an LLM, according to at least one embodiment of the present disclosure;

FIG. 5 is a flowchart of a method implemented on an LLM, according to at least one embodiment of the present disclosure;

FIG. 6 is a representation of a LLM system, according to at least one embodiment of the present disclosure;

FIG. 7 is a flowchart of a method implemented on an LLM, according to at least one embodiment of the present disclosure;

FIG. 8 is a flowchart of a method for processing LLM input data, according to at least one embodiment of the present disclosure;

FIG. 9 is a flowchart of a method implemented on an LLM, according to at least one embodiment of the present disclosure; and

FIG. 10 is a representation of a computing system, according to at least one embodiment of the present disclosure.

### DETAILED DESCRIPTION

This disclosure generally relates to devices, systems, and methods for preparing and/or processing input data at a large language model (LLM). LLMs analyze the language from input data to prepare responses to user queries. LLMs often utilize large quantities of input data to prepare the responses. The input data may be in the form of input documents. In some situations, the LLM may analyze the input documents and prepare a response to the query that is at least partially deficient. For example, the LLM may analyze the input documents and prepare a response that does not consider the entire input document or that separates portions of the input document that should not be separated. In some examples, the LLM may prepare a response that utilizes an out-of-date version of the input document.

In accordance with at least one embodiment of the present disclosure, the input documents may be edited to include one or more LLM tags. The LLM tag may include an instruction for the LLM to perform an action and/or process the input document in a particular manner. For example, upon identification of an LLM tag in an input document, the LLM may identify that a block of text in the input document is to be considered as a group. This may help to prevent the LLM from separating information from the block of text. In this manner, portions of the block of text may be considered together, thereby allowing their entire meaning to be processed by the LLM.

In some embodiments, the LLM tag may include a breakpoint. For example, the breakpoint LLM tag may include an instruction for the LLM to retrieve outside information. The outside information may include an escalation to a human operator for a decision point, an authorization to access the document and/or certain information within the document, a request for information from another document, a request for information from a user profile, a time of the query, a time of the document creation, any other outside information, and combinations thereof. Utilizing a breakpoint LLM tag may help to provide additional information to improve the accuracy and/or relevance of the response by the LLM.

In some embodiments, the LLM tag may include a version tag. A version tag may identify a version of the input document. In some situations, different versions of the same document may have different information. The LLM may limit the analysis of the input data to particular versions, such as versions generated before or after a particular date. In some embodiments, the query may include a request to analyze a particular version of a document and/or a particular version set of the document. The LLM may analyze the query for a matching query version tag and analyze the input data for input documents that have the associated document version tag. The LLM may limit processing of the input data and/or the input documents to the input documents having the version tag. This may help the LLM to prepare a response that is responsive to the query.

As illustrated by the foregoing discussion, the present disclosure utilizes a variety of terms to describe features and advantages of the LLM system. Additional detail is now provided regarding the meaning of such terms. For example, as used herein, the term “large language model (LLM)” refers to a computational system that identifies patterns within large datasets of documents including written language. The LLM may utilize machine learning, neural networks, other artificial intelligence system, and combinations thereof, to analyze patterns within the dataset. In some embodiments, an LLM may analyze data from a general dataset. In some embodiments, an LLM may analyze data from a specific dataset that is limited to a single topic, a series of topics, a particular group of documents, and so forth. In some embodiments, the techniques discussed herein may be applicable to any foundation model, including other artificial intelligence models, machine learning models, generative artificial intelligence, any other models, and combinations thereof.

As used herein, a “tag” is a markup that is identifiable by the LLM. The tag may provide instructions to the LLM, constrain the LLM, or otherwise impact how the LLM processes the input data. In some embodiments, the tag may be identified in the input data. In some embodiments, the tag may be located in an input query. In some embodiments, the tag may be located in the body of the input documents. In some embodiments, the tag may be located in the metadata of the input documents. In some embodiments, the tag may be formed from a scripting language. In some embodiments, the tag may be formed from natural language. In some embodiments, the tag may be formed from any type of language.

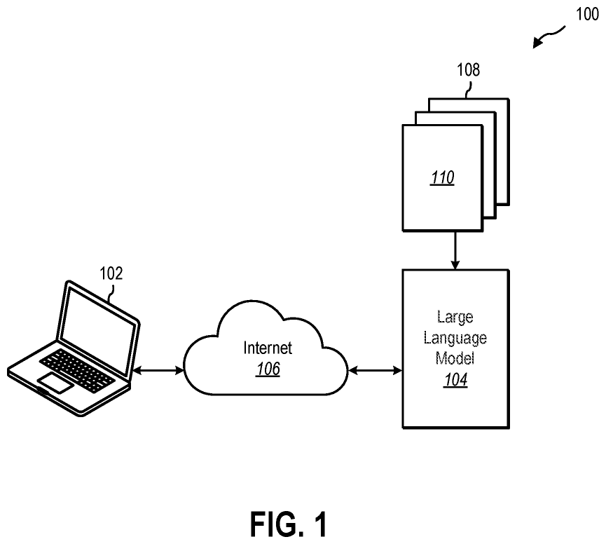

FIG. 1 is a representation of a LLM system 100, according to at least one embodiment of the present disclosure. The LLM system 100 includes an input device 102 connected to an LLM 104 over the Internet 106. The input device 102 may be any type of input device, such as a computing device, a laptop computer, a desktop computer, a mobile device (e.g., mobile phone, tablet), any other input device 102, and combinations thereof.

The LLM 104 may be trained from a set of input data 108. The input data 108 may be the data from which the LLM 104 may generate results to a query. The input data 108 may include any type of data, including text documents, internet webpages, spreadsheets, tables, databases, any other type of input data 108, and combinations thereof. In some embodiments, the input data 108 may all be of the same document type. In some embodiments, the input data 108 may be of different document types.

As discussed herein, conventional LLMs may include extensive training using various databases. But conventional LLMs may generate responses that are not verified for accuracy. This may lead to an LLM “hallucinating,” or creating a response that is unsupported by the input data 108. In some instances, an LLM hallucination may include erroneous information, made-up information, or may refer to references that do not exist. The techniques discussed herein may at least partially improve the verification and/or accuracy of responses to queries by an LLM 104.

In some embodiments, the LLM 104 may be specialized. For example, the LLM 104 may be specialized to provide answers to questions in a particular subject matter or topic, such as scientific topics, social matters, modern news and events, historical events, programming languages, any other topic, and combinations thereof. In some embodiments, the LLM 104 may be a general LLM. For example, the LLM 104 may not be limited to any document topic, subject matter, document type, or other element.

The input device 102 may receive a query for the LLM 104. The query may be received by the input device 102 in any manner. For example, the input device 102 may receive the query as a direct input from the user, such as by input text from a keyboard, input from a mouse, input from voice-recognition software, any other direct input, and combinations thereof. In some examples, the input device 102 may receive the query from another computing device.

The query may include any type of query. For example, the query may include a plain-language query. In some examples, the query may have a particular syntax that is parsed by the LLM 104. In some examples, the query may include a set of keywords identifiable by the LLM 104. As discussed in further detail herein, in some examples, the query may include an instruction for the LLM 104 to perform a particular action and/or process the input data 108 in a particular manner. In some examples, the query may include a query tag that points to an LLM tag that may be located in the input data 108.

The LLM 104 may receive the query and prepare a response to the query based on the input data 108. For example, the LLM 104 may analyze the language of the query and process the input data 108 to identify the response to the query. In accordance with at least one embodiment of the present disclosure, the input data 108 may include one or more LLM tags 110. When the LLM 104 is processing the input data 108, the LLM 104 may identify the LLM tag 110. When the LLM 104 identifies the presence of the LLM tag 110, the LLM 104 may process the input data 108 based on the LLM tag 110. This may help the LLM 104 to prepare a response to the query that has an increased relevance to the query.

As discussed herein, the LLM tag 110 may include a markup in the document text. The markup may provide an instruction to the LLM 104. The markup may provide any instruction to the LLM 104. For example, the markup may provide an instruction to the LLM 104 to consider a subset of the input data 108 as a group. Certain datasets or subsets of data should be considered together. As a non-limiting example, a dataset or subset of data may include a list of requirements for a refund, and each requirement must be met for the refund to be applied.

Consider a query that includes the question “what are the requirements for a refund?” The input data 108 may include one or more documents that outline the requirements for the refund. In some situations, the LLM 104 may analyze the input data 108 and identify one or more of the requirements. But the LLM 104 may not identify that all of the requirements for the refund must be met. This could result in a response to the query that is inaccurate.

In accordance with at least one embodiment of the present disclosure, the input data 108 may include an LLM tag 110 including an indication that all of the requirements are to be considered together. The LLM 104, upon identification of the LLM tag 110, may process the query by grouping all of the requirements together. In this manner, the response to the query may be more accurate and/or relevant to the query.

For example, the LLM tag 110 may be in the form of a scripting language. An illustrative example is provided below:

### <DoNotSeparateThisContent>

1. We offer refund and/or exchange within the first 30 days of your purchase, if 30 days have passed since your purchase, you will not be offered a refund and/or exchange of any kind.
2. Eligibility for Refunds and Exchanges
3. Your item must be unused and in the same condition that you received it.
4. The item must be in the original packaging.
5. To complete your return, we require a receipt or proof of purchase.
6. Only regular priced items may be refunded, sale items cannot be refunded.
7. If the item in question was marked as a gift when purchased and shipped directly to you, you will receive a gift credit for the value of your return.

### </DoNotSeparateThisContent>

As may be seen, the LLM tag 110 <DoNotSeparateThisContent> identifies the start of the subset of data that is to be considered together. The LLM tag 110 </DoNotSeparateThisContent> identifies the end of the subset of data that is not to be considered together. Upon identification of the LLM tag 110, the LLM 104 may not consider the subset of data separately. This may help to ensure that the response to the query is accurate based on the outlined policy. In this manner, a user acting on the response provided by the LLM 104 may have the knowledge to complete an effective return.

While the above example describes a refund policy, it should be understood that any subset of data may utilize information that should be considered as a whole. For example, the subset of data may include a series of prerequisites for a class. In some examples, the subset of data may include a recipe having a series of ingredients. In some examples, the subset of data may include any subset of data that should be considered together.

In embodiments, the LLM tag 110 may include one or more conditional operators. The conditional operators may apply conditional logic to how the LLM 104 processes the input data 108. The conditional operators may cause the LLM 104 to review different sets of the input data 108 based on a user access and/or qualifications, prepare different responses based on demographic data for the user, and/or present different information based on a status of the computing device. An illustrative example is provided below:

<if % user %=“Admin” then>
instructions to configure advanced software settings for a computing device
   <else>
instructions to configure basic software settings for the computing device
   <endif>

As may be seen, the LLM tag 110 <if> identifies the start of the conditional statement, bounded by the LLM tags 110 <else> and <endif>. The condition identified in the LLM tag 110 is <% user %==“Admin”>, which identifies the user of the computer, as identified through sign-in information or other user identification. The conditional operator <then> identifies the action to take if the user is identified as an Admin. The content includes instructions to configure advanced software settings for a computing device. If the user is not an Admin, then the conditional operator <else> causes the LLM 104 to analyze the instructions to configure basic software settings for the computing device. In this manner, different answers to a query may be provided to different sets of people. While the example above is provided with respect to information access based on user status, it should be understood that any conditional statement may be used by the LLM 104 to analyze the input data 108.

In some embodiments, the LLM tag 110 may include a copyright notice. For example, the LLM tag 110 may include a <copyright 2023> notice to indicate that the input data 108 is protected by copyright regulations. In some embodiments, the LLM tag 110 may include a conditional statement to determine whether the user has access to and/or a license to utilize the copyrighted content. This may help the operator of the LLM to ensure that the LLM is not infringing on copyrighted content. In some embodiments, the LLM tag 110 may include any other type of intellectual property notice, such as a notice regarding trade secrets (such as for internal input data 108 databases), trademarks, patents, and combinations thereof.

In some embodiments, the LLM tag 110 may identify other ways to process the input data 108 or subsets of the input data 108. In some embodiments, the LLM tag 110 may identify a subset of the input data 108 having information that should not be considered together, or two subsets of the input data 108 that should not be considered together. For example, the subset of data may include ingredients that should not be mixed. In some examples, the subset of data may include alternate policies that cannot be implemented at the same time. In some examples, the subset of data may include any two documents or sets of information that are not to be considered together.

In some embodiments, the LLM tag 110 may identify logical instructions to process the input data 108. For example, the LLM tag 110 may identify that certain subsets of data are to be considered together if certain conditions are met and/or not met. In some examples, the LLM tag 110 may identify that certain subsets of data are not to be considered together if certain conditions are met and/or not met. In this manner, the LLM tag 110 may cause the LLM 104 to provide a response that includes the information based on the logical instructions associated with the information.

In some embodiments, the LLM tag 110 may identify a particular order that information is to be considered in. For example, the LLM tag 110 may identify that a particular set of instructions are to be followed in a particular order to reach a particular result. In some examples, the LLM tag 110 may include instructions for a baking recipe, instructions to build a device, instructions to draw a drawing, any other instructions, and combinations thereof. In this manner, the LLM tag 110 may cause the LLM 104 to provide a response that includes the information and the order the information is to be presented in.

In accordance with at least one embodiment of the present disclosure, the LLM tag 110 may include a breakpoint tag in the input data 108 and/or a subset of the input data 108. The breakpoint tag may cause the analysis of the input data 108 by the LLM 104 to request and/or search for additional information. For example, in some embodiments, the breakpoint tag may cause the LLM 104 to escalate a question to a human operator. A non-limiting illustrative example of a breakpoint tag is provided below in the context of a threat modeling process:
1. Identify the known threats to the system.
2. Rank the threats in order by decreasing risk.
3. <escalate_to_human> Determine how you will respond to the threats. </escalate_to_human>
4. Identify techniques that mitigate the threats.
5. Choose the appropriate technologies from the identified techniques.

The breakpoint tag <escalate_to_human> may identify that the step of the threat modeling process including determining how to respond to a thread should be escalated to a human. The breakpoint tag </escalate_to_human> may identify the end of the portion of the threat modeling process that is to be escalated to a human. In some embodiments, a portion of the input data 108 may be escalated to a human because the LLM 104 may not be able to generate a response that is relevant to the query. In some embodiments, a portion of the input data 108 may be escalated to a human because the person who generated the input data 108 may wish to have input in the answer. In the example provided above, the portion of the input data 108 escalated to the human is a determination in how to respond to threats. Because the threat response may vary based on the person involved and/or the specifics of the threat, the LLM 104 may request that a human prepare the threat responses.

In some embodiments, the breakpoint tag may identify any type of additional information that the LLM 104 may utilize. For example, the breakpoint tag may identify a request for authorization to authorize a particular portion of the input data 108. The authorization may be based on access level, security level, need-to-know, any other authorization, and combinations thereof, of the requesting entity. In some examples, the breakpoint tag may identify a request for demographic information, such as a date and/or time of the query, a date and/or time of a particular event, age/gender/race of an individual, address of an individual, employment of an individual, details of a corporation or business entity, any other demographic information, and combinations thereof.

In some embodiments, the LLM tag 110 may include instructions that are executed post-ingestion of the input data 108 by the LLM 104 and after an end user prompt but prior to rendering the result. The LLM tag 110 of this manner may help to shape the output of the LLM 104 at the time of presentation to the end user. In this manner, the output of the LLM 104 may be tailored to the particular needs and/or desires of the user and/or the creator of the input data 108. In some embodiments, this may allow the LLM 104 to use a scripting language to generate an LLM tag 110 to render a custom answer that is available only at runtime by the user.

As a non-limiting example, the LLM tag 110 may include a location tag for post-ingestion rendering of an answer. Such response may include “It looks like you are in <% local time_zone %> so do you want us to call between 9 PM and 5 PM <% local time_zone %>?” Using this location tag, the LLM 104 may help to tailor the results to the user and/or the user's location. This may help to improve the relevance of the response to the query and/or the user experience.

While the example provided above is described with respect to a location, it should be understood that the LLM tag 110 may include any type of tag used post-processing. For example, the LLM tag 110 may include other demographic information, formatting preferences, any other post-ingestion information, and combinations thereof.

In some embodiments, the LLM tag 110 may include a version tag. The version tag may identify the version of the document. During processing, the LLM 104 may analyze the version of the documents in the input data 108. In some embodiments, the query may include a query version tag identifying that a particular version should be referenced by the LLM 104. When the LLM 104 receives the query, the LLM 104 may identify the query version tag and search the input data 108 for a matching document version tag. The LLM 104 may then analyze the version of the document having the matching document version tag and generate a response from that particular version.

As a non-limiting example, the query may include a request for information on how to perform an action in a particular version of software. As may be understood, different versions of software may utilize different commands and/or command sequences to perform the action. To ensure that the response is relevant to the particular version of software referenced in the query, the LLM 104 may identify a version tag in the input data 108 associated with the query version. In this manner, the LLM 104 may prepare a response that is relevant to the query.

While the example provided above is described with respect to software versions, it should be understood that the LLM tag 110 may refer to any version of a document. For example, the version tag may refer to a version of a document draft, a version of a textbook, any other version, and combinations thereof.

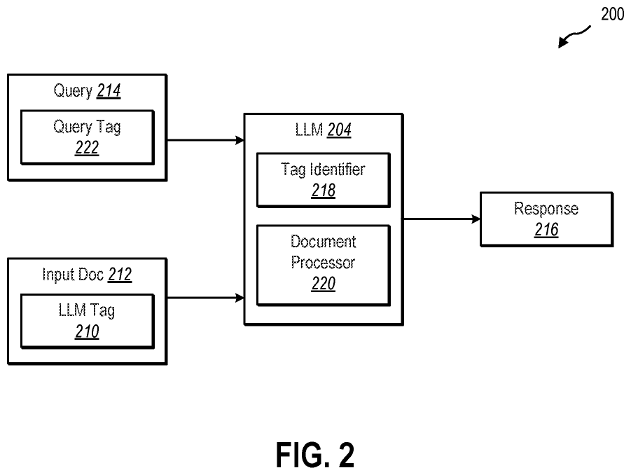

FIG. 2 is a representation of a LLM system 200 illustrating the flow of information through an LLM 204, according to at least one embodiment of the present disclosure. The LLM system 200 includes an LLM 204 that is trained to analyze one or more input documents 212 and/or is trained using the input documents 212. The LLM 204 may receive a query 214. As discussed herein, the LLM 204 may review the query 214 and prepare a response 216 based on the information in the input documents 212.

The input documents 212 may include one or more LLM tags 210. When the LLM 204 processes the input documents 212 to respond to the query 214, a tag identifier 218 may identify the LLM tag 210 in the input documents 212. A document processor 220 may process the input documents 212 according to the LLM tag 210 in the input documents 212. As discussed in further detail herein, the document processor 220 may process the input documents 212 to keep input data or a subset of the input data together, to respond to a breakpoint in the input documents 212, to identify a document version of the input documents 212. The LLM 204 may prepare the response 216 based on the instructions from the LLM tag 210.

As discussed herein, the LLM 204 may identify a query tag 222 in the query 214. The query tag 222 may indicate that the tag identifier 218 should review the input documents 212 for the LLM tag 210. In some embodiments, the query tag 222 may indicate whether or not the document processor 220 processes the input documents 212 based on the instructions in the LLM tag 210. In some embodiments, the query tag 222 may identify the document version of the input document 212 identified by the LLM tag 210.

In some embodiments, the query tag 222 may be an explicit tag. For example, the query tag 222 may be written in a scripting language that explicitly identifies the LLM tag 210 that the document processor 220 is to look for in the input documents 212. In some embodiments, the query tag 222 may be an implicit tag, or may be identified through context. For example, the LLM 204 may review the query 214 and identify elements of the query 214 that indicate the presence of an LLM tag 210 in the input documents 212. For example, the tag identifier 218 may review the query 214 to identify information such as a request to review the 2020 version of a software package. The tag identifier 218 may associate the 2020 version of the software package with a particular version number of the software. The tag identifier 218 may then review the input documents 212 for a version tag that has the software version number.

In some embodiments, the query tag 222 may include post-ingestion instructions for the LLM 204. The tag identifier 218 may identify the post-ingestion instructions and, after the document processor 220 processes the input documents 212, the LLM 204 may prepare the response 216 in accordance with the post-ingestion instructions.

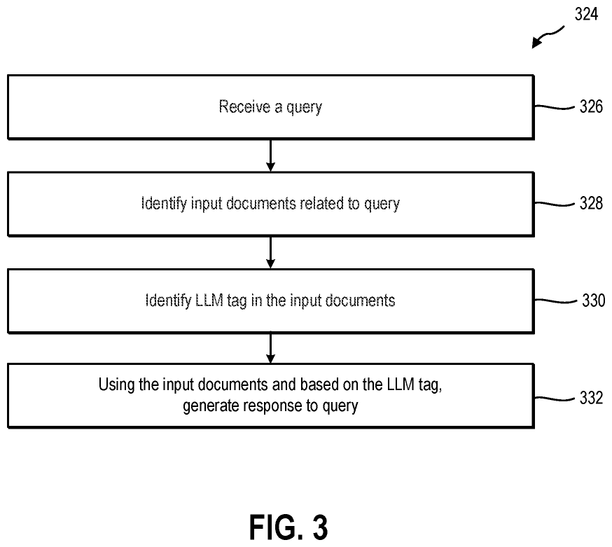

FIGS. 3-5, and 7-9, the corresponding text, and the examples provide a number of different methods, systems, devices, and computer-readable media of the LLM system. In addition to the foregoing, one or more embodiments can also be described in terms of flowcharts comprising acts for accomplishing a particular result, as shown in FIGS. 3-5, and 7-9. FIGS. 3-5, and 7-9 may be performed with more or fewer acts. Further, the acts may be performed in differing orders. Additionally, the acts described herein may be repeated or performed in parallel with one another or parallel with different instances of the same or similar acts.

As mentioned, FIG. 3 illustrates a flowchart of a method 324 or a series of acts for operating an LLM in accordance with one or more embodiments. The method 324 may be implemented at an LLM. While FIG. 3 illustrates acts according to one embodiment, alternative embodiments may omit, add to, reorder, and/or modify any of the acts shown in FIG. 3. The acts of FIG. 3 can be performed as part of a method. Alternatively, a computer-readable medium can comprise instructions that, when executed by one or more processors, cause a computing device to perform the acts of FIG. 3. In some embodiments, a system can perform the acts of FIG. 3.

The LLM may receive a query at 326. The query may include a question or other request for information related to a particular subject or topic. The LLM may review the query. Using the query, the LLM may identify input documents and/or input data that are related to the query at 328. For example, the LLM may identify a portion of the input data and/or a set of input documents that may be relevant to the subject of the query.

The LLM may identify an LLM tag in the input documents at 330. The LLM may identify that the LLM tag is in the input documents in any manner. For example, the LLM may review the input documents for portions of a scripting language. The scripting language may be unique to the LLM and/or specific to artificial intelligence, machine learning, or neural networks. The scripting language may be an existing scripting language that the LLM is capable of parsing. In some embodiments, the LLM tag may include a particular call or other identifier used by the LLM to identify the presence of the LLM tag.

The LLM may identify the content of the LLM tag. For example, the content of the LLM tag may include one or more instructions for the LLM. The LLM may identify the instructions in the content of the LLM tag. For example, the LLM may identify instructions to process certain portions of the dataset together. In some examples, the LLM may identify a breakpoint that requests external information in the LLM tag. In some examples, the LLM may identify any other instructions in the LLM tag.

In accordance with at least one embodiment of the present disclosure, the LLM may, using the input documents, and based on the LLM tag, generate a response to the query at 332. For example, the LLM may process the input documents to prepare a response to the query that is consistent with the instructions in the LLM tag. The response may include internal consistencies, such as data that is considered together based on the instructions in the LLM tag. The response may include external information, such as demographic information requested by the LLM. As discussed herein, processing the input data consistent with the instructions in the LLM tag may allow the LLM to generate a response to the query that is more relevant and/or more accurate.

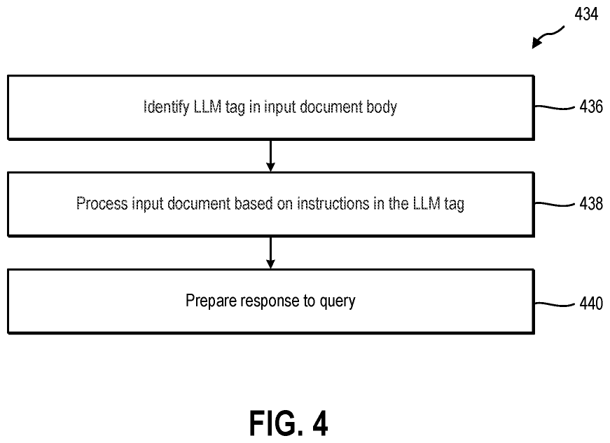

As mentioned, FIG. 4 illustrates a flowchart of a method 434 or a series of acts for operating an LLM in accordance with one or more embodiments. The method 434 may be implemented at an LLM. While FIG. 4 illustrates acts according to one embodiment, alternative embodiments may omit, add to, reorder, and/or modify any of the acts shown in FIG. 4. The acts of FIG. 4 can be performed as part of a method. Alternatively, a computer-readable medium can comprise instructions that, when executed by one or more processors, cause a computing device to perform the acts of FIG. 4. In some embodiments, a system can perform the acts of FIG. 4.

The LLM may identify an LLM tag in an input document body at 436. The LLM may process the input document based on instructions in the LLM tag at 438. As discussed herein, the LLM tag may include any type of instructions. For example, the LLM tag may include instructions to process a subset of data within the input document together. In some examples, the LLM tag may include instructions to process a subset of data independently of another subset of data. In some examples, the LLM tag may include instructions to exclude a subset of data from processing of the rest of the data. Based on the instructions in the LLM tag, the LLM may prepare a response to a query at 440.

As discussed herein, In some embodiments, the LLM may identify the LLM tag in the text or body of the input document. In some embodiments, the LLM may identify the LLM tag in the metadata of the input document.

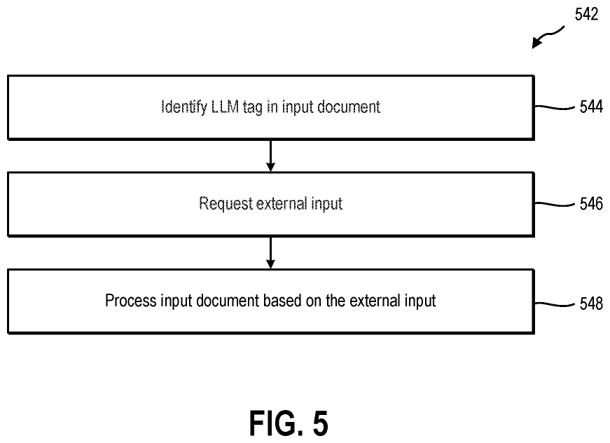

As mentioned, FIG. 5 illustrates a flowchart of a method 542 or a series of acts for operating an LLM in accordance with one or more embodiments. The method 542 may be implemented at an LLM. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

The LLM may identify an LLM tag in an input document body at 544. In accordance with at least one embodiment of the present disclosure, the LLM tag may include a breakpoint. At the breakpoint, the LLM may request external input at 546. Using the external input, the LLM may process the input document based on the external input at 548. For example, as discussed herein, the LLM may request additional demographic information that is relevant to the request and/or relevant to the input data in the document. In some examples, the LLM may request access or security credentials.

Requesting external input may help to improve the relevance of the response of the LLM to the query. For example, receiving external input related to the user's demographic may help the LLM to prepare a response to the query that is focused on the demographic information. In some examples, receiving external input authorizing access to a particular input document or set of input documents may allow the LLM to prepare the response to the query based on the authorized input document or the authorized input data.

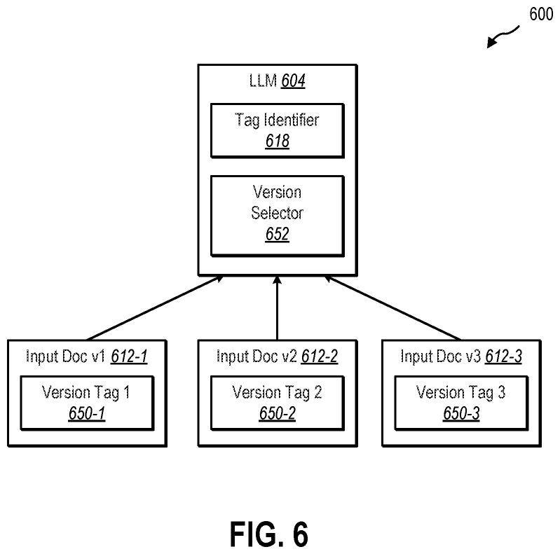

FIG. 6 is a representation of a LLM system 600, according to at least one embodiment of the present disclosure. The LLM system 600 includes an LLM 604. The LLM 604 may utilize as input one or more input documents (collectively 612). The input document 612 may have or include a set of versions. The versions may be different versions of the same document. For example, the versions of the input document 612 may represent changes to the input document 612 as the input document 612 is updated. In some examples, the versions of the input document 612 may represent additions, subtractions, and/or revisions to the input document 612. Different versions of the same document may have different information. As a non-limiting example, the input document 612 may include a description and/or instructions related to a software program. New versions of the input document 612 may be generated for new versions of the software program and/or new sub-version of the software program.

As may be understood, a new version of software may have different features. These different features may have different descriptions and/or instructions. In some situations, different versions of the input document 612 may have conflicting instructions. In some situations, in response to a query related to the software program, an LLM may prepare the response based on an input document 612 that is not associated with the version of the software program about which the query asked. This may result in a response that may not be relevant to the query and/or is contradictory to the query.

In accordance with at least one embodiment of the present disclosure, the input document 612 may include a version tag (collectively 650). The version tag 650 may identify a particular version of the input document 612. For example, a first version input document 612-1 may have a first version tag 650-1, a second version input document 612-2 may have a second version tag 650-2, and a third version input document 612-3 may have a third version tag 650-3. Each of the versions may include different information.

The LLM 604 may include a tag identifier 618. The tag identifier 618 may analyze the input document 612 and identify the version of the input document 612 based on the version tag 650. For example, when the LLM 604 receives the input document 612, the tag identifier 618 may identify the first version input document 612-1 based on the first version tag 650-1, the second version input document 612-2 based on the second version tag 650-2, and the third version input document 612-3 based on the third version tag 650-3.

In some embodiments, the tag identifier 618 may identify a version tag in the query. For example, the tag identifier 618 may review the query and identify an explicit version tag in the text of the query. In some examples, the tag identifier 618 may review the query and identify through the language of the query a version tag. For example, the tag identifier 618 may identify a version of the software program about which the query is asking. Using the context of the query, the tag identifier 618 may identify the version of the input document 612 that is to be used. In this manner, the tag identifier 618 may identify a query version tag from the query. The query version tag may be associated with the input document 612 that may be used to answer the query.

The LLM 604 may include a version selector 652. The version selector 652 may receive the query version tag and select the associated version of the input document 612. For example, the version selector 652 may compare the query version tag with the document version tags 650 in the different versions of the input document 612. The version selector 652 may identify which version of the input document 612 to utilize to respond to the query. For example, the version selector 652 may identify a version tag 650 that matches the query version tag from the query.

As a non-limiting example, the LLM 604 may receive a query that asks, “How do I change the settings for video quality in MICROSOFT TEAMS in version 3.11?” The tag identifier 618 may identify a query version tag of version 3.11 for the software program MICROSOFT TEAMS. The tag identifier 618 may review the available input documents 612 that may answer the query for MICROSOFT TEAMS and their associated version tags 650. The tag identifier 618 may identify which of the input documents 612 that may answer the query have a matching version tag 650 for the input document 612. The version selector 652 may select the input document 612 having the matching version tag 650 for processing by the LLM 604. The LLM 604 may then prepare a response to the query using the input document 612 having the matching version tag 650. In this manner, the LLM 604 may prepare a response that is relevant to the query.

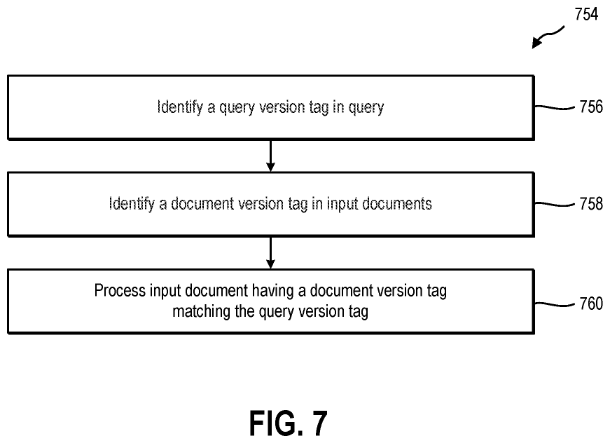

As mentioned, FIG. 7 illustrates a flowchart of a method 754 or a series of acts for operating an LLM in accordance with one or more embodiments. The method 754 may be implemented at an LLM. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

The LLM may identify a version query tag in a query at 756. The LLM may identify a document version tag in one or more input documents at 758. The LLM may respond to the query by processing input documents having a document version tag that matches the query version tag at 760. For example, as discussed herein, the LLM may analyze the query for a query version tag. The LLM may identify the query version tag using context from the query and/or an explicit query version tag written in an explicit scripting language.

The LLM may identify one or more input documents that may be responsive to the query. The LLM may analyze the input documents to identify a document version tag. The document version tag may be located in any portion of the document, such as the header, the footer, the body of the input document, metadata, any other portion of the input document, and combinations thereof.

In some embodiments, the LLM may limit the processing of the input documents to only those that have a matching document version tag. In some embodiments, the LLM may exclude versions of the document that do not have matching document version tag. In some embodiments, the LLM may include in their processing any document that is relevant to the query and not excluded by a version tag that matches the query version tag. As discussed herein, processing the input document having a document version tag matching the query version tag may help to increase the relevance and/or accuracy of the response to the query.

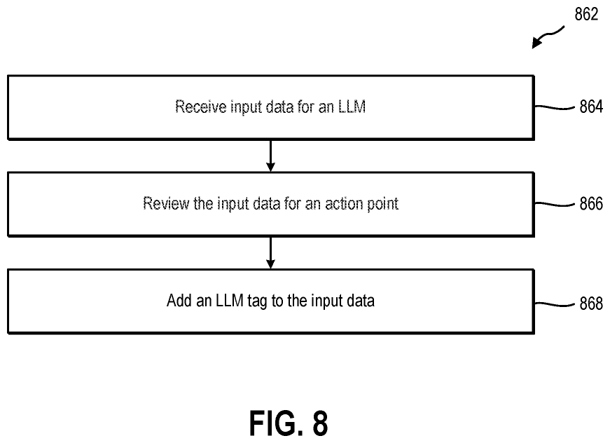

As mentioned, FIG. 8 illustrates a flowchart of a method 862 or a series of acts for preparing data to be used in an LLM, in accordance with one or more embodiments. The method 862 may be implemented at an LLM. While FIG. 8 illustrates acts according to one embodiment, alternative embodiments may omit, add to, reorder, and/or modify any of the acts shown in FIG. 8. The acts of FIG. 8 can be performed as part of a method. Alternatively, a computer-readable medium can comprise instructions that, when executed by one or more processors, cause a computing device to perform the acts of FIG. 8. In some embodiments, a system can perform the acts of FIG. 8.

In accordance with at least one embodiment of the present disclosure, an LLM input data system may receive input data for an LLM at 864. The LLM input data system may review the input data for an action point at 866. An action point may be any action point that is relevant to the LLM. For example, the LLM input data system may review the input data to determine whether a subset of information should be processed together. If the subset of information should be processed together, then the LLM input data system may identify an action point to instruct the LLM to process the subset of data together. In some examples, the LLM input data system may review the input data to determine whether the LLM should ask for external input. If the LLM input data system determines that the LLM should ask for external input, the LLM input data system may identify an action point to establish a breakpoint to request external input. In some examples, the LLM input data system may review the input data to determine whether the input data has multiple versions of the same document. If the LLM input data system identifies multiple versions of the same document, the LLM input data system may identify an action point to label the different versions with a version tag.

In accordance with at least one embodiment of the present disclosure, if the LLM input data system identifies an action point, then the LLM input data system may add an LLM tag to the input data at 868. Adding the LLM tag to the input data may occur in any manner. For example, adding the LLM tag to the input data may include adding the LLM tag to the text in the body of the input data. In some examples, adding the LLM tag to the input data my include adding the LLM tag to the metadata of the input data and/or input documents. In some examples, adding the LLM tag to the input data may include adding the LLM tag to any other portion of the input data.

The LLM tag may be based on or associated with the action point. For example, for an action point instructing the LLM to keep a subset of information together, the LLM tag may be a keep-with-next LLM tag. In some examples, for an action point instructing the LLM to request external input, the LLM tag may be a breakpoint tag with an instruction to ask for the external input. In some examples, for an action point indicating a label for the different versions with a version tag, the LLM tag may be a version tag. In some embodiments, preparing the input data with an LLM tag may help to improve the relevance and/or confidence in the response prepared by the LLM in response to a query.

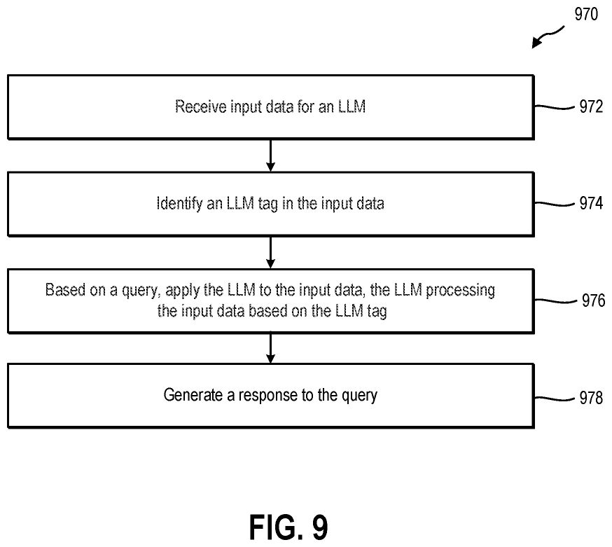

As mentioned, FIG. 9 illustrates a flowchart of a method 970 or a series of acts for preparing data to be used in an LLM, in accordance with one or more embodiments. The method 970 may be implemented at an LLM. While FIG. 9 illustrates acts according to one embodiment, alternative embodiments may omit, add to, reorder, and/or modify any of the acts shown in FIG. 9. The acts of FIG. 9 can be performed as part of a method. Alternatively, a computer-readable medium can comprise instructions that, when executed by one or more processors, cause a computing device to perform the acts of FIG. 9. In some embodiments, a system can perform the acts of FIG. 9.

An LLM may receive input data for an LLM at 972. The LLM may identify an LLM tag in the input data at 974. As discussed herein, the LLM may identify any type of LLM tag in the input data, including a keep-with-next LLM tag, a breakpoint LLM tag, a version LLM tag, any other LLM tag, and combinations thereof. In some embodiments, the LLM may identify the type of LLM tag. In some embodiments, the LLM may identify instructions in the LLM tag.

In some embodiments, the LLM may, based on a query received at the LLM, apply the LLM to the input data at 976. The LLM may process the input data based on the LLM tag. For example, the LLM may process the input data based on the instructions within the LLM tag. In some examples, the LLM may process the input data based on the type of the LLM tag. In some embodiments, the LLM may generate a response to the query at 978. As discussed herein, the response generated by the LLM may be more relevant to the query and/or have a higher confidence in the correct answer based on the query.

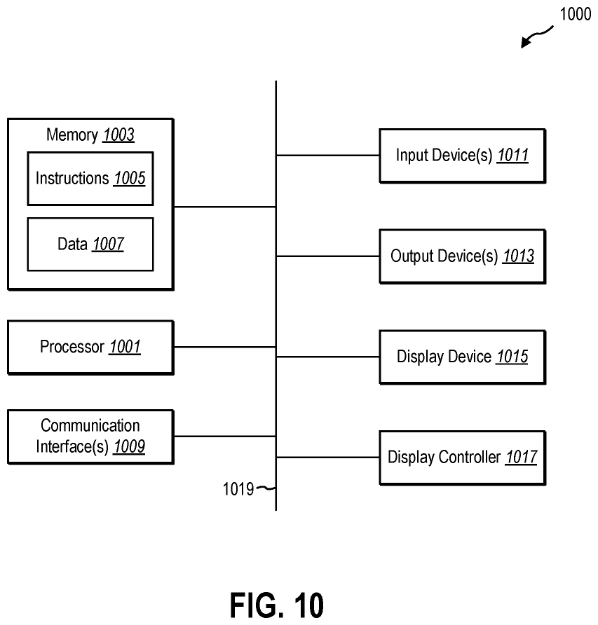

FIG. 10 illustrates certain components that may be included within a computer system 1000. One or more computer systems 1000 may be used to implement the various devices, components, and systems described herein.

The computer system 1000 includes a processor 1001. The processor 1001 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). Although just a single processor 1001 is shown in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1005 and data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during execution of the instructions 1005 by the processor 1001.

A computer system 1000 may also include one or more communication interfaces 1009 for communicating with other electronic devices. The communication interface(s) 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 may also include one or more input devices 1011 and one or more output devices 1013. Some examples of input devices 1011 include a keyboard, mouse, microphone, remote control device, button, joystick, trackball, touchpad, and lightpen. Some examples of output devices 1013 include a speaker and a printer. One specific type of output device that is typically included in a computer system 1000 is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1019.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method implemented by a large language model (LLM), comprising:
receiving input data for the LLM;
identifying an LLM tag in the input data wherein the LLM tag includes an operator to process a subset of the input data;
based on a query, processing the subset of the input data with the LLM based on the LLM tag and the operator in the LLM tag; and
generating a response to the query from the LLM.

2. (canceled)

3. (canceled)

4. The method of claim 1, wherein the operator causes the LLM to process the subset of the input data based on a user identification.

5-20. (canceled)

21. The method of claim 4, wherein the user identification is a first user identification and the subset of the input data is a first subset of the input data, and wherein the operator causes the LLM to process the first subset of the input data based on the first user identification and a second subset of the input data based on a second user identification.

22. The method of claim 21, wherein the first user identification is an admin user.

23. The method of claim 1, wherein the operator causes the LLM to process a subset of the input data together.

24. The method of claim 1, wherein the operator causes the LLM to not consider portions of the subset of the input data separately.

25. The method of claim 1, wherein the operator is added to a body of the input data.

26. The method of claim 1, wherein the operator is written in a scripting language.

27. A method implemented by a large language model (LLM), comprising:
receiving input data for the LLM;
identifying an LLM tag in the input data, wherein the LLM tag includes a breakpoint identifying a request for external information;
based on a query, processing the input data with the LLM based on the LLM tag;
when the LLM processes the LLM tag, the LLM stops processing the input data to request the external information;
receiving the external information at the LLM;
processing the input data with the LLM based at least in part on the external information; and
generating a response to the query from the LLM.

28. The method of claim 27, wherein the request for external information includes a request for information from a human operator.

29. The method of claim 27, wherein the request for external information includes a request for demographic information.

30. The method of claim 27, wherein the request for external information includes a request for input authorizing access to at least a portion of the input data.

31. The method of claim 30, wherein processing the input data includes processing the portion of the input data after receiving authorization to access the input data.

32. The method of claim 27, wherein the request for external information includes a request for security credentials.

33. A method implemented by a large language model (LLM), comprising:
receiving input data for the LLM;
identifying an LLM tag in the input data, wherein the LLM tag includes a version tag identifying a document version of the input data;
based on a query, processing the input data with the LLM based on the LLM tag, wherein processing input data includes processing the input data having the version tag; and
generating a response to the query from the LLM.

34. The method of claim 33, wherein processing the input data having the version tag includes excluding the input data not having the version tag.

35. The method of claim 33, wherein the query includes a query tag, and wherein the version tag matches the query tag.

36. The method of claim 35, further comprising identifying the query tag based on context in the query.

37. The method of claim 35, further comprising identifying the query tag based on an explicit query tag in the query.

38. The method of claim 35, wherein the query tag includes an instruction for the LLM to process the document version of the input data.
